(19) United States
(12) Patent Application Publication
(10) Pub. No.: US 2026/0126783 A1
(43) Pub. Date: May 7, 2026

(54) Application of Choreography Mechanisms within an Automated Module

(71) Applicant: Siemens Aktiengesellschaft, Muenchen (DE)

(72) Inventors: Andreas STUTZ, Eggenstein-Leopoldshafen (DE); Mathias MAURMAIER, Gerlingen (DE)

(21) Appl. No.: 19/116,450

(22) PCT Filed: Sep. 30, 2022
(86) PCT No.: PCT/EP2022/077343

§ 371 Date: Mar. 28, 2025

(51) Int. Cl. G05B 19/418

(52) U.S. Cl. CPC G05B 19/41845; G05B 19/4185; G05B 19/4188

(57) ABSTRACT

A technical module includes a plurality of technical objects that are each configured to implement a technical function, a control unit configured to control the technical functions of individual technical objects, and a communication unit configured to exchange data with external communication partners, wherein the control unit comprises a computer-implemented execution service having a configurable logic unit, where the computer-implemented execution service is configured to receive rules and interconnections from an external communication partner via the communication unit, and configure the logic unit based on the received rules and interconnections, and where the control unit is configured to control, via the configured logic unit, the technical objects for operating the technical module in the technical plant.

### CROSS-REFERENCE TO RELATED APPLICATIONS

This is a U.S. national stage of application No. PCT/EP 2022/077343 filed 30 Sep. 2022.

### BACKGROUND OF THE INVENTION

### 1. Field of the Invention

The invention relates to a technical installation, a method for operating a technical module in the technical installation, a computer program with program code instructions which are executable by a computer, a computer-readable medium and a technical module, comprising a plurality of technical objects that are each configured to perform a technical function, a control unit configured to control the technical functions of the individual technical objects, and a communication unit configured to exchange data with external communication partners.

### 2. Description of the Related Art

Primarily in the pharmaceutical and specialty chemicals industries, heavy demands are placed on the operators of technical installations to be able to react rapidly to changing market requirements. Modular installations enable the installation operators to shorten the time-to-market significantly and to react rapidly to altered market conditions by re-structuring the installation with little effort. For this purpose, the installation operators can build up a pool of modular units (for example, process units), with the aid of which they can assemble a specific installation via “orchestration”. If the installation is to be restructured, then individual modules are removed and are replaced with other, for example, more efficient, modules.

In conventional automation systems, such as “PCS 7” or the “TIA portal” from Siemens, classic concepts of automation technology are used to connect the modules in terms of communication technology and actuate the functions thereof. In this context, communication connections are project-engineered, operator displays are developed and higher-level execution sequences are created with languages such as “S7-graph” or “SFC (sequential flow chart)”. This is complex and, due to a lack of relevant experience on the part of process technicians, can only be performed with difficulty.

WO 2016/074730 A1 describes a method for creating a modular technical installation via self-description information regarding the modules. This method is based upon self-description information regarding the individual modules that is available online. In an orchestration process of a modular installation, however, this information is typically not available (online), because planning occurs offline based on statistical type description information, such as the module type package (MTP) (see the proposal for the standard “VDI/VDE/NAMUR 2658” published on Jan. 4, 2018 by the Verein Deutscher Ingenieure (VDI) (Association of German Engineers) ).

In general, the flexibility and adaptivity of production systems represents a key factor for future production systems in volatile markets. These can be achieved through the orchestration of intelligent technical modules (also referred to as “equipment assemblies” or “package units”) for an installation. In this context, each technical module offers functions, which are parameterized by a higher-level orchestration entity (also referred to as “orchestration layer”) and can be called in the correct order.

The more the functions are divided into small parts, the greater the flexibility when orchestrating larger functions therefrom. However, functions divided into small parts require a higher level of effort for the coordination and engineering thereof. If a technical module offers somewhat less granular functions, then these are too specific for many application cases, which in turn restricts the flexibility.

In the process industry, following the Instruction Set Architecture 88 (ISA-88) or International Electrotechnical Commission (IEC) 61512 standards, a procedural model is available that describes various levels of granularity for the individual functions. Starting from the highest level of a “procedure”, generally also referred to as a recipe, this is followed by three further levels with functions that are divided into increasingly smaller parts (“unit procedure”, “operation”, “phase”). As the functions are divided into smaller parts, the effort for coordinating these functions increases. In addition to procedural relationships, regulatory and interlocking relationships then also have greater importance.

Today, both central and decentralized orchestration approaches are used for the orchestration of functions. Both variants work exclusively on the procedural level to merge functions divided into small parts to form a larger function (“procedure” or “unit procedure”).

In a central orchestration, the “unit operation” is implemented by the installation operator in the orchestration entity through the orchestration of functions divided into small parts, via purely procedural relationships, mostly resolved via step transition logic. Here, the orchestration in the orchestration entity also requires the consideration of regulatory and interlocking relationships. To this end, the orchestration entity possesses a data hub, which reads values from a source and writes to a sink. Between the reading and writing, there is the possibility to insert configurable conversions in the orchestration entity. In addition to the effort for the implementation of the “unit operation” in the orchestration entity, the orchestration of the functions divided into small parts and the realization of the regulatory and interlocking relationships bring high performance requirements and real-time requirements for the orchestration entity.

As part of a decentralized orchestration, the “unit operation” is implemented natively in a (control) program of a controller of the technical module. A step transition logic is also generally used here. Regulatory and interlocking tasks can be realized within the controller of the technical module in this case. In this solution, however, the flexibility is restricted, because the function at the level of a “unit operation” must be highly specific for a particular application case. The mechanical engineer who develops the technical module, produces it, tests it and (in some industries) sells it with corresponding validation certificates in many cases does not have the process knowledge for the realization of the “unit operation” in the technical module.

### SUMMARY OF THE INVENTION

It is an object of the present invention to simplify an integration of a technical module in a technical installation and the operation of the technical module, and to make these more efficient.

These and other objects and advantages are achieved in accordance with the invention by a technical module comprising a plurality of technical objects that are each configured to perform a technical function, a control unit configured to control the technical functions of the individual technical objects, and a communication unit configured to exchange data with external communication partners.

The control unit of the technical module has a computer-implemented execution service with a configurable logic unit, where the computer-implemented execution service is configured to receive rules and interconnections from an external communication partner by means of the communication unit, and to performed a configuration of the logic unit based on the received rules and interconnections, where the control unit is configured to use the configured logic unit to implement control of the technical objects for operation of the technical module in the technical installation.

A “technical module” is understood to mean a discrete technical unit that can be integrated into a (higher-level) control level of the technical installation. Such a technical module can be, for example, a combination of a plurality of measuring sites or a relatively large portion of the technical installation. A technical module can comprise any given combination of individual control elements, sensors, actuators or automation components. Software-related mappings of individual control elements, for example, additionally can also be part of a technical module.

The technical module comprises a plurality of technical objects, with the aid of which a technical process can be performed. For example, a technical object can be a boiler, with which a liquid can be heated, or a conveyor belt, with which a medium or an object can be conveyed.

The technical module comprises (at least) one control unit, in addition to the technical objects that are configured to perform the process. This controls (and, if appropriate, regulates) the technical objects based on rules and interconnections that are or can be stored in the technical module. These can be partially specified by a manufacturer of the technical module and stored in the technical module.

The technical module can be configured to execute a complex function in the technical installation, for example, perform controlled pumping of liquid, heat water and maintain a particular temperature in a tank, and/or execute filter functionality. For this purpose, the technical module can have, for example, valves, tanks, sensors, and/or combinations of a plurality of individual objects as technical objects.

Rules and interconnections that can be implemented in the configurable logic unit of the computer-implemented execution service of the control unit are used in this context for the execution or the performance of one or more processes within the functional module with the aid of the technical objects contained in the functional module. For example, rules can be specified as to how the control unit (or control units) of the functional module is to control the technical objects, for example, as a function of a chosen operating mode.

The (automation-related) rules and interconnections that can be stored in the technical module are used in this context to link the individual technical objects to one another. Parts of the interconnections can be, for example, identifications and specifications of the individual technical objects that must be known to the individual technical objects in each case in order to be able to interact with one another.

However, it is also possible for part of such an interconnection, for example, to be the information that the stirrer in a tank, after a particular fill level of the fluid in the tank, is only permitted to rotate at the reduced speed of n rpm.

The technical module has a communication unit that is used for a data exchange with external communication partners. This communication unit can comprise a server, in particular an Open Platform Communications Unified Architecture (OPC UA) server.

A significant innovation in relation to conventional technical modules is the implementation of the configurable logic unit and the execution service in the technical module. In this context, “in the technical module” means that both the logic unit and the execution service are computer-implemented on computing/storage units, which are physically part of the technical module.

The execution service is configured, via the communication unit, to receive the rules and interconnections from an external communication partner, for example, a higher-level orchestration tool of the technical installation. The rules and interconnections can involve, for example, one or more process-related operations that are to be executed sequentially by the technical module. Here, it is not only the operations that can be requested per se. Rather, the rules and interconnections can also comprise parameters associated with the process-related operations. In particular, the rules and interconnections can comprise a (process-related) recipe, which is to be performed by the technical module in full or in part.

The execution service performs a configuration of the logic unit based on the rules and interconnections received by the communication partner and thereby specifies the rules and interconnections for the individual technical objects. In the simplest case, the received rules and interconnections are adopted 1:1 in this context and are inserted into the logic unit. It is also possible, however, for (minor) adaptations of the received rules and interconnections to be performed by the execution service, in order to meet the specific requirements of the logic unit.

In this context, the logic unit can have computer-implemented functional blocks, which are configured in a corresponding manner by the execution service. It is possible that particular rules and interconnections for the individual technical objects are already stored in the technical module, and that the configuration of the logic unit leads to a revised interconnection of the technical objects, which is (only) valid for the execution of the instructed operation(s). It can be provided that rules and interconnections already stored in the technical module, which have been created by the manufacturer of the technical module, for example, cannot be changed due to the received external rules and interconnections.

Through the embodiment according to the invention of the technical module, it is possible to overcome the disadvantages of the prior art and realize an advantageous compromise consisting of decentralized choreography and central orchestration.

The logic unit can comprise a memory, in which it is possible to store the rules and interconnections generated by the triggering by the execution service. In this context, a separate memory or a memory of the control unit can be used as a shared memory. By way of the execution service and the configurable logic unit, the technical module is configured in an adaptive manner and can effectively adapt to changing usage conditions within a technical installation (or on a change into another technical installation).

The communication unit can further have a server, in particular an OPC UA server, for communication with external communication partners, such as a control system. The communication unit can also have an archive, in which it is possible to store information regarding communication with external communication partners, such as network addresses of the communication partners.

As part of an advantageous embodiment of the invention, one or more technical functions can be addressed by the control unit as a service that can be performed in accordance with the VDI/VDE/NAMUR 2658 standard. Specifically in the context of modular production or manufacturing, this standard is becoming more and more accepted, whereby a correspondingly configured technical module can be integrated into an automation of a technical installation in a particularly simple manner.

The communication unit is preferably configured to obtain rules and interconnections, which relate to which service or which services are to be performed, from the external communication partner, for example, an orchestrating control system, and to forward these to the control unit. For example, it is possible to specify a recipe, i.e., a sequence of particular process-related or manufacturing-related steps, which necessitates the execution of one or more services offered by the technical module.

The objects and advantages are also achieved in accordance with the invention by a technical installation, in particular manufacturing or process installation, comprising at least one technical module in accordance with the disclosed embodiments, and at least one higher-level controller unit configured separately from the technical module.

The technical installation can involve an installation from the process industry, for example, a chemical, pharmaceutical or petrochemical installation, or an installation from the food and beverage industry. This also includes any technical installations from the production industry, factories in which, for example, automobiles or goods of all kinds are produced. Wind turbines, solar installations or power stations for energy generation are also included by the expression technical installation.

Preferably, the technical installation comprises a visualization system that is configured to visualize the rules and interconnections used for controlling the technical objects of the technical module. With the aid of such a graphical representation, the technical module can be integrated or orchestrated in a more simple and efficient manner into the technical installation for the performance of a technical process. It is possible, via the visualization system, to obtain an overview of the rules and interconnections that are currently applicable or active in the technical module and to supplement them if necessary. The visualization information necessary for the visualization can be transmitted to the visualization system in a format in accordance with the VDI/VDE/NAMUR 2658 standard mentioned above.

The higher-level controller unit can be configured as a control system, which comprises an operator station server for the visualization and/or the orchestration of the technical module. Here, an “operator station server” is understood in this context to mean a server that centrally captures data of an operator control and monitoring system and generally also alarm and measurement value archives of the control system of the technical installation, and makes this data available to users. The operator station server generally establishes a communication connection to automation systems of the technical installation and forwards data of the technical installation to what are known as clients for the purpose of operator control and monitoring of an operation of the individual function elements of the technical installation. The operator station server can have client functions for accessing the data (archives, messages, tags, variables) of other operator station servers. This means that images of an operation of the technical installation on the operator station server can be combined with variables of other operator station servers (server-server communication). The operator station server can be a SIMATIC PCS 7 industrial workstation server from SIEMENS, without being restricted thereto.

The objects and advantages are also achieved in accordance with the invention by a method for operating a technical module in a technical installation, in particular manufacturing or processing installation, where the technical module comprises a plurality of technical objects that are each configured to perform a technical function, a control unit configured to control the technical objects based on rules and interconnections of the individual objects, and which has a configurable logic unit, and a communication unit configured to exchange data with external communication partners, where the method comprises:
a) integration of the technical module into the technical installation, where as part of this a communication connection between the technical module and a higher-level controller unit of the technical installation, in particular a control system of the technical installation, is configured,
b) transfer of rules and interconnections to the communication unit via the higher-level controller unit as an external communication partner of the technical module, and forwarding rules and interconnections to a computer-implemented execution service of the control unit,
c) automated configuration of the configurable logic unit based on the received rules and interconnections via the computer-implemented execution service, and
d) control of the technical objects via the configured logic unit for operating the technical module in the technical installation.

In this context, method step b preferably occurs based on a server, in particular an OPC UA server.

As part of a embodiment of the disclosed embodiments of the inventive method, the communication unit receives information regarding a communication unit of the external communication partner, in particular regarding a network address of the communication unit of the external communication partner, and stores this in an archive of the communication unit of the technical module.

The rules and interconnections used to control the technical objects of the technical module can be visualized via a visualization system, in particular an operator station server or client of a control system of the technical installation.

The objects and advantages are also achieved in accordance with the invention by a computer program with program code instructions that can be executed by a computer to implement the method in accordance with disclosed embodiments and by a computer-readable medium, comprising commands which, when execution by a processor of a computer, cause the processor to implement the method in accordance with the disclosed embodiments.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above-described properties, features and advantages of this invention and the manner in which these are achieved will become clearer and more intelligible in conjunction with the following description of exemplary embodiments that are explained in further detail in conjunction with the drawings, in which:

FIG. 1. is a schematic block diagram of a technical installation with modular construction in accordance with the invention; and

FIG. 2 is a flowchart of the method in accordance with the invention.

### DETAILED DESCRIPTION OF THE EXEMPLARY EMBODIMENTS

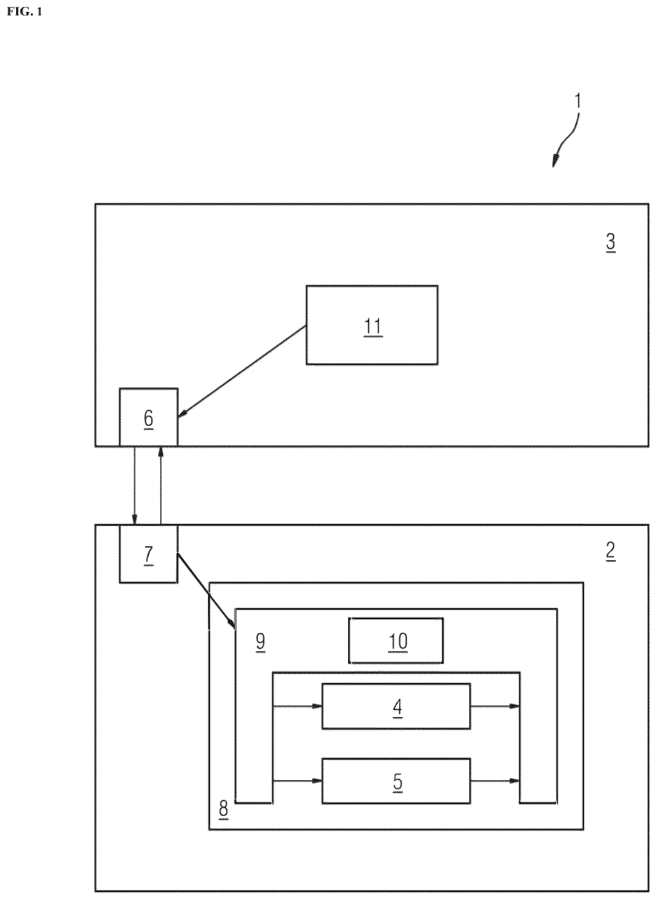

FIG. 1 shows a technical installation 1 with modular construction. The technical installation 1 comprises a technical module 2 and a higher-level controller unit 3. In this exemplary embodiment, the higher-level controller unit 3 represents an operator station of a control system for the technical installation. The operator station has at least an operator station server and an operator station client, via which it is possible to perform operator control and monitoring of the technical installation with the technical module 2. However, it is also possible to use a single-user system (single station) as the higher-level controller unit 3. The technical module 2 is configured for modular use in the technical installation. For this purpose, it has a plurality of technical objects such as sensor and actuators, which are configured for exercising technical functions 4, 5. A technical function can represent, for example, a heating, a stirring, a moving, and/or a measuring.

The higher-level controller unit 3 has a communication unit 6, via which it can transfer rules and interconnections to a communication unit 7 of the technical module 2. In the inverse direction, the communication unit 7 of the technical module 2 can transmit data to the communication unit 6 of the higher-level controller unit 3. Here, the transfer in the direction of the higher-level controller unit 3 can come from the communication unit 6 of the technical module 2 or can be requested by the communication unit 7 of the higher-level controller unit 3.

Implemented in the technical module 2 is a control unit 8, which is configured for controlling the technical objects of the technical module 2 based on rules and interconnections of the individual objects. The control unit 8 has a computer-implemented execution service 9, which has access to a configurable logic unit 10 of the control unit 8.

A method for operating the technical module 2 in the technical installation 1 is explained below:
First, the technical module 2 is integrated into the technical installation 1. In this context, logical steps are performed, which are not explained in further detail here (lines, energy supply, placement, etc.) . As part of the configuration, a communication connection between the communication unit 7 of the technical module 2 and the communication unit 6 of the higher-level controller level 3 of the technical installation is configured.

Rules and interconnections are transferred from the communication unit 6 of the higher-level controller level 3 to the communication unit 7 of the technical module 2 automatically or by manual specification by an operator of the technical installation. Here, the rules and interconnections can comprise a recipe 11. The recipe 11 contains one or more steps, which are to be processed by the technical module 2.

Here, the recipe 11 also comprises parameters that are relevant to the processing of the individual steps. For example, a recipe 11 can comprise the following information:
Fill 100 liters of fluid A from intake 1 into a container X
Heat the fluid to a temperature of 100 degrees Celsius
Mix the heated fluid A with 10 liters of a fluid B from intake 2
Allow the mixture of fluid A and fluid B to cool down to temperature of 30 degrees Celsius
Direct the cooled mixture into a container Y.

The communication unit 7 of the technical module 2 forwards the received rules and interconnections to the computer-implemented execution service 9 of the control unit 8. This configures the configurable logic unit 10 based on the received rules and interconnections. Here, the rules and interconnections can partially follow the formal structure in accordance with the VDI/VDE/NAMUR 2658 standard and address individual “services” offered as services by the technical module 2. Here, the object of the computer-implemented execution service 9 is to transfer the requests for the performance of particular services internally to the individual technical functions 4, 5, wherein it uses the configurable logic unit 10 here, which it configures according to the rules and interconnections.

In the configurable logic unit 10, for example, it is possible to store that the status of a valve has direct influence on the locking of a pump. It is also possible to store in the logic unit 10 that the valve is locked if the pump has been reported as defective.

Finally, the technical module 2 is operated in the technical installation 1. In this context, it is possible for data (e. g., measurement values, diagrams, and/or reports) to be transferred via the communication unit 7 of the technical module 2 to the higher-level controller level 3, which is used for operator control and monitoring of the technical module 2.

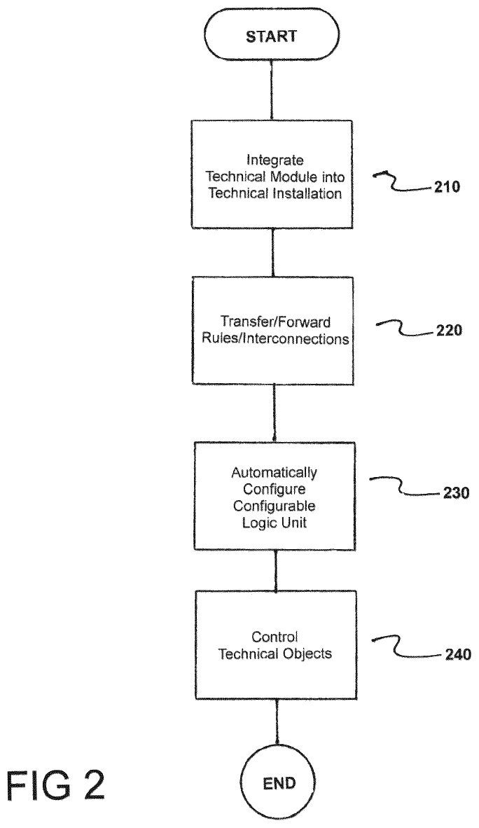

FIG. 2 is a flowchart of the method for operating a technical module 2 in a technical installation 1, where the technical module 2 comprises a plurality of technical objects that are each configured to perform a technical function 4, 5, a control unit 8 configured to control the technical objects of the individual objects, a communication unit 7 configured to exchange data with external communication partners 3, 6.

The method comprises a) integrating the technical module 2 into the technical installation 1, as indicated in step 210. In accordance with the method, the integration includes configuring a communication connection between the technical module 2 and a higher-level controller unit 6 of the technical installation 1, where the controller unit 6 comprises a control system of the technical installation 1.

Next, b) rules and interconnections are transferred to the communication unit 7 via the higher-level controller unit 6 as an external communication partner 3, 6 of the technical module 2, and the rules and interconnections are forwarded to a computer-implemented execution service 9 of the control unit 8, as indicated in step 220.

Next, c) a configurable logic unit 10 is automatically configured based on the received rules and interconnections via the computer-implemented execution service 9, as indicated in step 230.

Next, d) the technical objects are controlled via the configured logic unit 10 to operate the technical module 2 in the technical installation 1, as indicated in step 240.

Although the invention has been illustrated and described in detail with the preferred exemplary embodiment, the invention is not restricted by the examples given and other variations can be derived therefrom by a person skilled in the art without departing from the protective scope of the invention.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. A technical module, comprising:
a plurality of technical objects which are each configured to perform a technical function;
a control unit configured to control the technical functions of individual technical objects of the plurality of technical objects; and
a communication unit configured to exchange data with external communication partners;
wherein the control unit includes a computer-implemented execution service with a configurable logic unit;
wherein the computer-implemented execution service is configured to:
receive rules and interconnections from an external communication partner via the communication unit; and
implement a configuration of the logic unit on the basis of the received rules and interconnections; and
wherein the control unit is configured to use the configured logic unit to control the technical objects for operation of the technical module in the technical installation.

17. The technical module as claimed in claim 16, wherein the communication unit includes a server for bidirectional communication between the technical module and the external communication partner.

18. The technical module as claimed in claim 16, wherein the server is an Open Platform Communications Unified Architecture (OPC UA) server.

19. The technical module as claimed in claim 16, wherein at least one technical function is addressable by the control unit as a service which is performable in accordance with the VDI/VDE/NAMUR 2658 standard.

20. The technical module as claimed in claim 17, wherein at least one technical function is addressable by the control unit as a service which is performable in accordance with the VDI/VDE/NAMUR 2658 standard.

21. The technical module as claimed in claim 19, wherein the communication unit is configured to obtain rules and interconnections, which relate to which service or which services are to be performed, from the external communication partner, and to forward the obtained rules and interconnections to the control unit.

22. A technical installation, comprising at least one technical module as claimed in claim 16, and at least one higher-level controller unit formed separately from the at least one technical module.

23. The technical installation as claimed in claim 22, wherein the technical installation comprises a manufacturing or process installation.

24. The technical installation as claimed in claim 22, wherein the higher-level controller unit comprises a computer-implemented editing tool which is configured to specify the rules and interconnections; and wherein the higher-level controller unit includes a communication unit for transferring the rules and interconnections to the communication unit of the at least one technical module.

25. The technical installation as claimed in claim 22, wherein the higher-level controller unit is formed as a control system which comprises at least one operator station server.

26. The technical installation as claimed in claim 24, wherein the higher-level controller unit is formed as a control system which comprises at least one operator station server.

27. The technical installation as claimed in claim 22, wherein the technical installation is configured to visualize the rules and interconnections for an operator of the technical installation.

28. The technical installation as claimed in claim 24, wherein the technical installation is configured to visualize the rules and interconnections for an operator of the technical installation.

29. The technical installation as claimed in claim 25, wherein the technical installation is configured to visualize the rules and interconnections for an operator of the technical installation.

30. A method for operating a technical module in a technical installation, the technical module comprising a plurality of technical objects which are each configured to perform a technical function, a control unit configured to control the technical objects of the individual objects, a communication unit configured to exchange data with external communication partners, the method comprising:
a) integrating the technical module into the technical installation, said integrating including configuring a communication connection between the technical module and a higher-level controller unit of the technical installation;
b) transferring rules and interconnections to the communication unit via the higher-level controller unit as an external communication partner of the technical module, and forwarding the rules and interconnections to a computer-implemented execution service of the control unit;
c) configuring automatically a configurable logic unit based on the received rules and interconnections via the computer-implemented execution service;
d) controlling the technical objects via the configured logic unit for operating the technical module in the technical installation.

31. The method as claimed in claim 30, wherein the controller unit comprises a control system of the technical installation.

32. The method as claimed in claim 30, wherein the technical installation is a manufacturing or processing installation.

33. The method as claimed in claim 30, wherein step b) occurs based on a server architecture.

34. The method as claimed in claim 33, wherein the server architecture comprises an Open Platform Communications Unified Architecture (OPC UA) server architecture.

35. The method as claimed in claim 30, wherein the communication unit of the technical module receives information regarding a communication unit of the external communication partner and stores the received information in an archive of the communication unit of the technical module.

36. The method as claimed in claim 33, wherein the communication unit of the technical module receives information regarding a communication unit of the external communication partner and stores the received information in an archive of the communication unit of the technical module.

37. The method as claimed in claim 35, wherein the received information comprises a network address of the communication unit of the external communication partner.

38. The method as claimed in claim 36, wherein the received information comprises a network address of the communication unit of the external communication partner.

39. The method as claimed in claim 30, wherein at least one technical function is addressable by the control unit as a service which is performable in accordance with the VDI/VDE/NAMUR 2658 standard.

40. The method as claimed in claim 39, wherein the communication unit of the technical module obtains the rules and interconnections from the higher-level controller unit, and forwards the obtained rules and interconnections to the control unit, such that the rules and interconnections specify which service or which services are to be performed.

41. A computer program with program code instructions which when executed by a computer implement the method as claimed in claim 30.

42. A non-transitory computer-readable medium encoded with program commands which, when executed by a processor of a computer, cause operation of a technical module in a technical installation, the technical module comprising a plurality of technical objects which are each configured to perform a technical function, a control unit configured to control the technical objects of the individual objects, a communication unit configured to exchange data with external communication partners, the program commands comprising:
a) program code for integrating the technical module into the technical installation, said integrating including configuring a communication connection between the technical module and a higher-level controller unit of the technical installation;
b) program code for transferring rules and interconnections to the communication unit via the higher-level controller unit as an external communication partner of the technical module, and forwarding the rules and interconnections to a computer-implemented execution service of the control unit;
c) program code for automatically configuring a configurable logic unit based on the received rules and interconnections via the computer-implemented execution service;
d) program code for controlling the technical objects via the configured logic unit for operating the technical module in the technical installation.
